(19) United States
(12) Patent Application Publication
(10) Pub. No.: US 2017/0309269 A1
(43) Pub. Date: Oct. 26, 2017

(54) INFORMATION PRESENTATION SYSTEM

(71) Applicant: MITSUBISHI ELECTRIC CORPORATION, Tokyo (JP)

(72) Inventors: Naoya BABA, Tokyo (JP); Yuki FURUMOTO, Tokyo (JP); Takumi TAKEI, Tokyo (JP); Tatsuhiko SAITO, Tokyo (JP); Masanobu OSAWA, Tokyo (JP)

(73) Assignee: MITSUBISHI ELECTRIC CORPORATION, Tokyo (JP)

(21) Appl. No.: 15/516,844

(22) PCT Filed: Nov. 25, 2014
(86) PCT No.: PCT/JP2014/081087

§ 371 Date: Apr. 4, 2017

(51) Int. Cl. G10L 13/02; G06F 17/27; G10L 13/08

(52) U.S. Cl. CPC G10L 13/02; G10L 13/08; G06F 17/2735; G06F 17/2765

(57) ABSTRACT

An information presentation system 1 includes: an extraction unit 12 configured to extract, from among linguistic units such as word strings included in a reading text, additional information related to the linguistic units which is capable of being acquired from an information source, as a word-of-speech-recognition target; a synthesis controller 13 configured to output accent information for use in speech-synthesis for reading out the reading text, and the word-of-speech-recognition target extracted by the extraction unit 12; a speech synthesizer 14 configured to read out the reading text using the accent information received from the synthesis controller 13; and a display controller 15 configured to control a display 4 to display the word-of-speech-recognition target received from the synthesis controller 13, in synchronization with a timing where the speech synthesizer 14 reads out the word-of-speech-recognition target.

### TECHNICAL FIELD

The present invention relates to an information presentation system for reading out a text to thereby present information to a user.

### BACKGROUND ART

Heretofore, among information presentation devices for acquiring a text from an information source such as a Web, etc., to present it to a user, there is a device that, when a keyword included in the thus-presented text is spoken by the user, phonetically recognizes that keyword to thereby further acquire and then present information corresponding to that keyword.

According to the information presentation device using such speech-recognition, it is necessary to explicitly present which word is a speech-recognition target in the text, to the user.

In this respect, in Patent Literature 1, as a way to explicitly present the word-of-speech-recognition target to the user, such a method is described in which, among hyper-text information acquired from a Web, at least a part of a descriptive text (word(s) subject to speech-recognition) about a linked file, is emphatically displayed on a screen. Likewise, in Patent Literature 2, such a method is described in which, among content information acquired from the outside, the word (s) subject to speech-recognition is displayed after being modified in display form, on a screen.

### CITATION LIST

### Patent Literatures

Patent Literature 1: Japanese Patent Application Publication No.H11(1999)-25098.

Patent Literature 2: Japanese Patent Application Publication No.2007-4280.

### SUMMARY OF INVENTION

### Technical Problem

With respect to devices whose screen is small, such as in-vehicle devices or similar devices, there are cases where the text is presented to the user in a manner that it is not displayed on the screen but is read out. In these cases, it is unable to apply the methods as described in Patent Literatures 1 and 2.

In addition, when the screen is small, the number of displayable characters is restricted, so that there are cases where, if the text is to be displayed on the screen, the text is not fully displayed thereon. In these cases, according the methods as described in Patent Literatures 1 and 2, the word-of-speech-recognition target is possibly not displayed on the screen, due to the character number restriction, making it unable to explicitly show the word-of-speech-recognition target to the user.

This invention has been made to solve the problems as described above, and an object of the invention is to explicitly present, even when a text to be read out is not displayed on the screen or the number of displayable characters on the screen is restricted, the word-of-speech-recognition target included in the text to the user.

### Solution to Problem

An information presentation system according to the invention comprises: an extraction unit configured to extract, from among words or word strings being included in a text, information related to the words or word strings which is capable of being acquired from an information source, as a word-of-speech-recognition target; a synthesis controller configured to output information for use in speech-synthesis for reading out the text, and the word-of-speech-recognition target extracted by the extraction unit; a speech synthesizer configured to read out the text using the information received from the synthesis controller; and a display controller configured to control a display unit to display the word-of-speech-recognition target received from the synthesis controller, in synchronization with a timing where the speech synthesizer reads out the word-of-speech-recognition target.

### Advantageous Effect of Invention

According to the invention, when a text is read out, the word-of-speech-recognition target therein is displayed at the timing where it is read out, so that, even when the text to be readout is not displayed on the screen or the number of displayable characters on the screen is restricted, it is possible to explicitly present the word-of-speech-recognition target included in the text, to the user.

### BRIEF DESCRIPTION OF DRAWINGS

FIG. 1 is a diagram schematically illustrating an information presentation system and peripheral devices thereof, according to Embodiment 1 of the invention.

FIG. 2 is a diagram showing a display example on a display according to Embodiment 1.

FIG. 3 is a schematic diagram showing a main hardware configuration of the information presentation system and the peripheral devices thereof, according to Embodiment 1.

FIG. 4 is a block diagram showing a configuration example of the information presentation system according to Embodiment 1.

FIG. 5 is a flowchart showing operations of an information-processing control unit in the information presentation system according to Embodiment 1.

FIG. 6 is a flowchart showing an example of operations by the information presentation system when a user speaks a word-of-speech-recognition target in Embodiment 1.

FIG. 7 is a block diagram showing a configuration example of an information presentation system according to Embodiment 2.

FIG. 8 is a flowchart showing operations of an information-processing control unit in the information presentation system according to Embodiment 2.

Fig. 9 is a block diagram showing a configuration example of an information presentation system according to Embodiment 3.

FIG. 10 is a flowchart showing operations of an information-processing control unit in the information presentation system according to Embodiment 3.

### DESCRIPTION OF EMBODIMENTS

Hereinafter, for illustrating the invention in more detail, embodiments for carrying out the invention will be described in accordance with the accompanying drawings.

It is noted that, in the following embodiments, the information presentation system according to the invention will be described citing, as an example, a case where it is applied to a navigation apparatus for a vehicle or like moving object; however, the system may be applied to, other than the navigation apparatus, a PC (Personal Computer) or a portable information terminal such as a tablet PC, a smartphone, etc.

### Embodiment 1

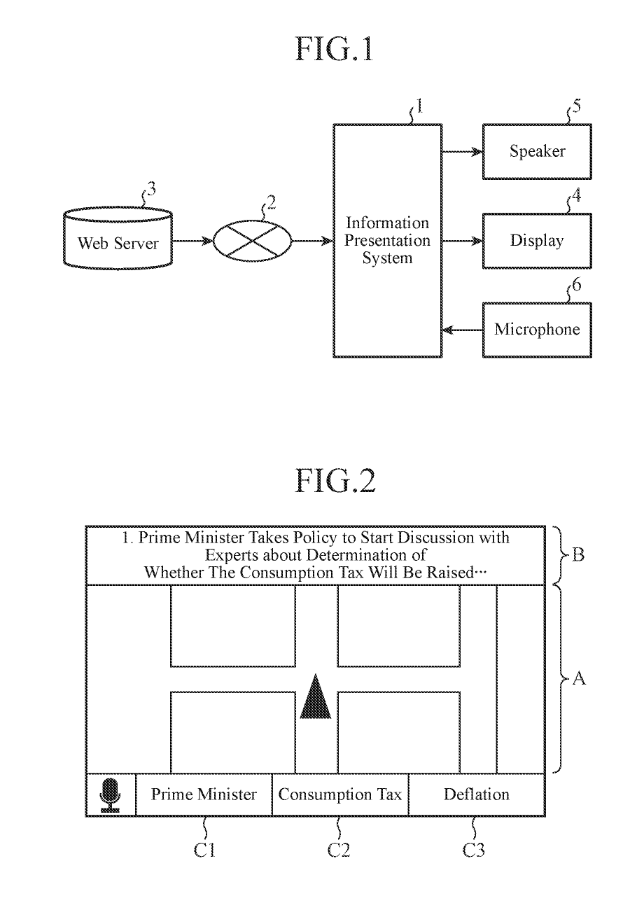

FIG. 1 is a diagram schematically illustrating an information presentation system 1 and peripheral devices thereof, according to Embodiment 1 of the invention.

The information presentation system 1 acquires a reading text from an external information source, such as a Web server 3, etc., through a network 2, and then controls a speaker 5 to output by voice the acquired reading text.

In addition, the information presentation system 1 may control a display (display unit) 4 to display the reading text.

Further, at the timing of reading out a word or word string that is included in the reading text and subject to speech-recognition, the information presentation system 1 controls the display 4 to display that word or word string. Hereinafter, the word or word string is referred to as a “linguistic unit such as a word string”, and the linguistic unit such as a word string that is subject to speech-recognition is referred to as “word-of-speech-recognition target”.

When a word-of-speech-recognition target is spoken by a user, the information presentation system 1 recognizes the spoken voice by acquiring it through a microphone 6, and then controls the speaker 5 to output by voice, information related to the recognized linguistic unit such as a word string. Hereinafter, the information related to the linguistic unit such as a word string, is referred to as “additional information”.

FIG. 2 shows a display example on the display 4. In this embodiment, descriptions will be made assuming that the reading text is “Prime Minister takes policy to start discussion with experts about determination of whether the consumption tax will be raised, ‘to reconsider if departure from deflation is difficult’”, and the word-of-speech-recognition targets are “prime minister”, “consumption tax” and “deflation”.

In a display area A on the display 4, a navigation screen in which the host-vehicle position, the map and the like are shown, is displayed, so that a display area B for displaying the reading text is narrow. Thus, the reading text cannot be fully displayed at once in the display area B. For that reason, the information presentation system 1 displays only a part of the reading text, and outputs all the text by voice.

Instead, when the display area B cannot be established, the information presentation system 1 may output only by voice the reading text, without displaying that text.

The information presentation system 1 displays “prime minister”, “consumption tax” and “deflation”, that are the word-of-speech-recognition targets, in their display areas C1, C2 and C3 on the display 4, at the respective timings where they are read out. Then, when “consumption tax”, for example, is spoken by the user, the information presentation system 1 presents to the user, the additional information related to “consumption tax” (for example, the meaning of “consumption tax”, a detailed explanation thereof, or the like), by outputting the information by voice through the speaker 5, or doing something like that. Note that, although the three display areas are prepared in this case, the number of the display areas may not be limited to three.

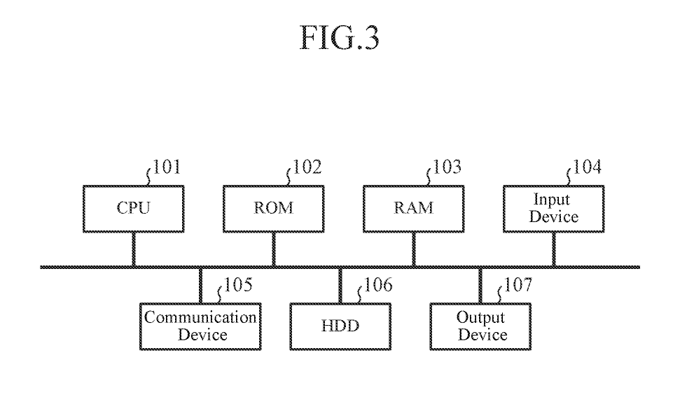

FIG. 3 is a schematic diagram showing a main hardware configuration of the information presentation system 1 and the peripheral devices thereof, according to Embodiment 1. To a bus, a CPU (Central Processing Unit) 101, a ROM (Read Only Memory) 102, a RAM (Random. Access Memory) 103, an input device 104, a communication device 105, an HDD (Hard Disk Drive) 106 and an output device 107, are connected.

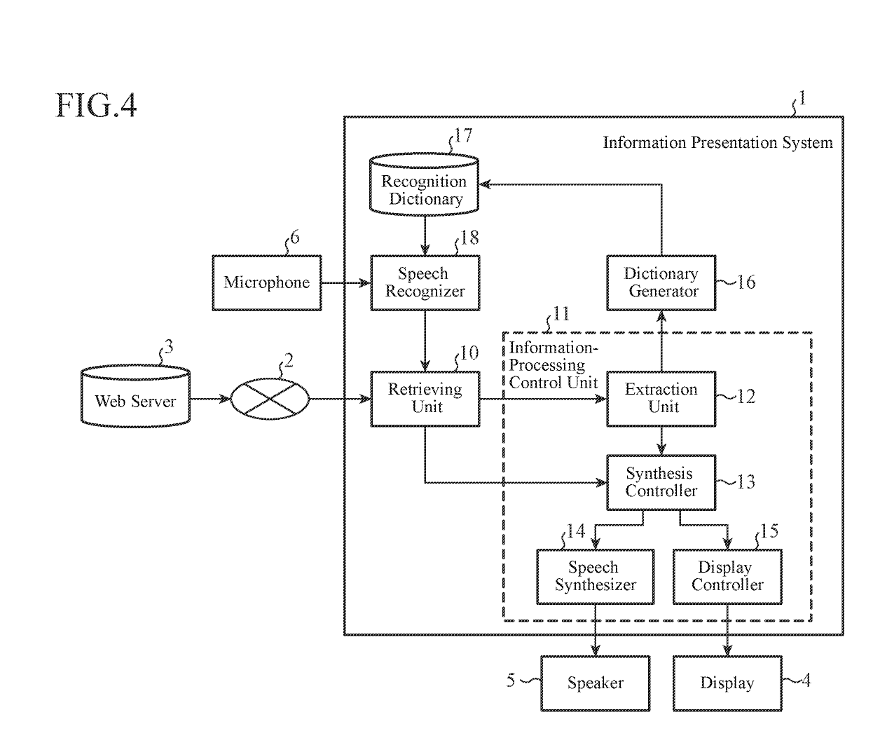

The CPU 101 reads out a variety of programs stored in the ROM 102 and/or the HDD 106 and executes them, to thereby implement a variety of functions of the information presentation system 1 in cooperation with the respective pieces of hardware. The variety of functions of the information presentation system 1 implemented by the CPU 101 will be described using later-mentioned FIG. 4.

The RAM 103 is a memory to be used under program execution.

The input device 104 is a device which receives a user's input, and is a microphone, a remote controller or like operation device, a touch sensor, or the like. In FIG. 1, the microphone 6 is illustrated as an example of the input device 104.

The communication device 105 is that which performs communications through the network 2.

The HDD 106 is an example of an external storage device. Other than the HDD, examples of the external storage device include a CD/DVD, flash-memory based storage such as a USB memory, an SD card, or the like.

The output device 107 is that which presents information to the user, and is a speaker, an LCD display, an organic EL (Electroluminescence) and/or the like. In FIG. 1, the display 4 and the speaker 5 are illustrated as an example of the output device 107.

FIG. 4 is a block diagram showing a configuration example of the information presentation system 1 according to Embodiment 1.

The information presentation system 1 includes a retrieving unit 10, an extraction unit 12, a synthesis controller 13, a speech synthesizer 14, a display controller 15, a dictionary generator 16, a recognition dictionary 17 and a speech recognizer 18. The functions of these units are implemented when the CPU 101 executes the programs for them.

The extraction unit 12, the synthesis controller 13, the speech synthesizer 14 and the display controller 15 constitute an information-processing control unit 11.

It is noted that, the retrieving unit 10, the extraction unit 12, the synthesis controller 13, the speech synthesizer 14, the display controller 15, the dictionary generator 16, the recognition dictionary 17 and the speech recognizer 18, that constitute the information presentation system 1, may be consolidated in a single device as shown in FIG. 4, or may be distributed over a server on the network, a portable information terminal such as a smartphone, etc., and an in-vehicle device.

The retrieving unit 10 retrieves a content written in HTML (HyperText Markup Language) or XML (eXtensible Markup Language) format from the Web server 3 through the network 2. Then, the retrieving unit 10 analyzes the retrieved content to thereby acquire a reading text to be presented to the user.

Note that, as the network 2, the Internet or a public line for mobile phone or the like, may be used, for example.

The extraction unit 12 analyzes the reading text acquired by the retrieving unit 10 to segment the text into linguistic units such as word strings. As a method of the segmentation, it suffices to use a publicly known method, such as morphological analysis, for example, so that its description is omitted here. Note that the unit of division is not limited to a morpheme.

In addition, the extraction unit 12 extracts from the linguistic units such as word strings obtained by the segmentation, each word-of-speech-recognition target. The word-of-speech-recognition target is a linguistic unit such as a word string included in the reading text, for which additional information related to that linguistic unit such as a word string (for example, the meaning of the linguistic unit such as a word string, or a detailed explanation thereof) can be acquired from an information source.

Note that the information source of the additional information may be an external information source such as the Web server 3 on the network 2, or may be a database (not shown) or the like that the information presentation system 1 has. The extraction unit 12 may be connected through the retrieving unit 10 to the external information source on the network 2, or may be directly connected thereto, not through the retrieving unit 10.

Furthermore, the extraction unit 12 determines each number of morae from the beginning of the reading text to each word-of-speech-recognition target in that reading text.

In the case of the above-described reading text of “Prime Minister takes policy to start discussion with experts about determination of whether the consumption tax will be raised, ‘to reconsider if departure from deflation is difficult’”, the number of morae [in Japanese] from the beginning of the reading text [in Japanese] is provided as “1” for “prime minister”, as “4” for “consumption tax”, and as “33” for “deflation”.

The synthesis controller 13 determines, for all of the reading text, information about accents or the like (hereinafter, described as “accent information”) that is required at the time of voice synthesis. Then, the synthesis controller 13 outputs the determined accent information to the speech synthesizer 14.

Note that, as a determination method of the accent information, it suffices to use a publicly known method, so that its description is omitted here.

In addition, the synthesis controller 13 calculates, for each word-of-speech-recognition target determined by the extraction unit 12, start times for voice outputs on the basis of the number of morae from the beginning of the reading text to the word-of-speech-recognition target. For example, a speed for reading out per one more is predetermined in the synthesis controller 13, so that the start times for voice outputs of the word-of-speech-recognition target is calculated in such a manner that the number of morae up to that word-of-speech-recognition target is segmented by that speed. Then, the synthesis controller 13 counts time from when outputting the accent information for the reading text is started to the speech synthesizer 14, and outputs the word-of-speech-recognition target to the display controller 15 when the time reaches the estimated start times for voice outputs. This makes it possible to display the word-of-speech-recognition target in synchronization with the timing where that word-of-speech-recognition target is read out.

Note that, the time is counted from when the outputting is started to the speech synthesizer 14; however, as will be described later, the time may be counted from when the speech synthesizer 14 controls the speaker 5 to output a synthesized voice.

The speech synthesizer 14 generates the synthesized voice, based on the accent information outputted from the synthesis controller 13, and then controls the speaker 5 to output the synthesized voice.

Note that, as a synthesis method of that voice, it suffices to use a publicly known method, so that its description is omitted here.

The display controller 15 controls the display 4 to display the word-of-speech-recognition target outputted from the synthesis controller 13.

The dictionary generator 16 generates the recognition dictionary 17 by using the word-of-speech-recognition target extracted by the extraction unit 12.

With reference to the recognition dictionary 17, the speech recognizer 18 recognizes the voice collected by the microphone 6, to thereby output a recognition result word string.

Note that, as a recognition method of that voice, it suffices to use a publicly known method, so that its description is omitted here.

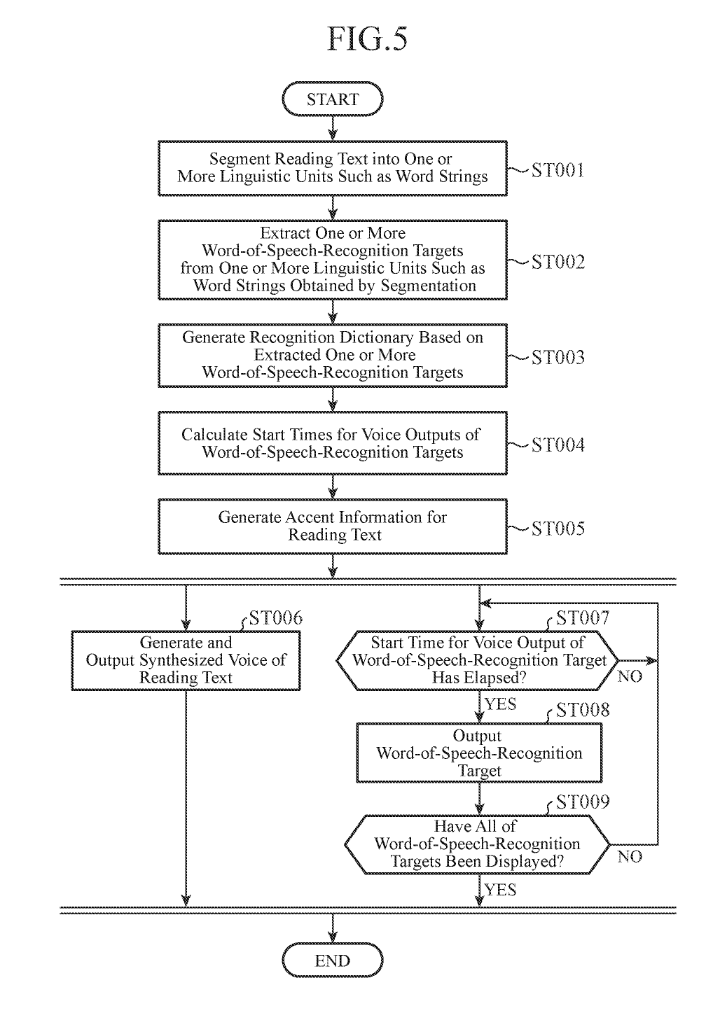

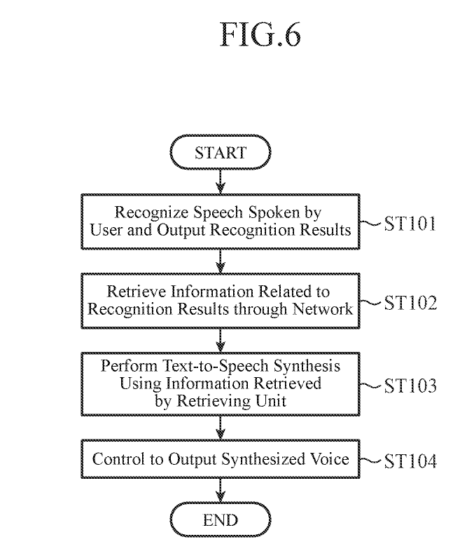

Next, operations of the information presentation system. 1 of Embodiment 1 will be described using flowcharts shown in FIG. 5 and FIG. 6, and a specific example.

First, operations of the information-processing control unit 11 will be described using the flowchart in FIG. 5.

Here, descriptions will be made assuming that the reading text is “Prime Minister takes policy to start discussion with experts about determination of whether the consumption tax will be raised, ‘to reconsider if departure from deflation is difficult’”, and the word-of-speech-recognition targets are “prime minister”, “consumption tax” and “deflation”.

Initially, the extraction unit 12 segments the above reading text into one or more linguistic units such as word strings (Step STOOL). Here, the extraction unit 12 performs morphological analysis to thereby segment the above reading text into “/Prime Minister/, /takes/policy/to/start/discussion/with/experts/about/, /determination/of/whether/, /the/consumption tax/will/ be/raised/‘/to/reconsider/if/departure/from/deflation/is/difficult/’”.

Subsequently, the extraction unit 12 extracts from the linguistic units such as word strings obtained by the segmentation, the word-of-speech-recognition targets: “prime minister”, “consumption tax” and “deflation” (Step ST002).

On this occasion, the dictionary generator 16 generates the recognition dictionary 17, based on the three word-of-speech-recognition targets of “prime minister”, “consumption tax” and “deflation” extracted by the extraction unit 12 (Step ST003).

Subsequently, using the number of morae from the beginning of the reading text to the word-of-speech-recognition target: “prime minister” and using the speed for reading out, the synthesis controller 13 calculates the start time for the voice output of “prime minister” when the reading text is read out (Step ST004). Likewise, the synthesis controller 13 calculates, based on the number of morae up to each of the word-of-speech-recognition targets “consumption tax” and “deflation”, the start time for the voice output of each of them.

In addition, the synthesis controller 13 generates the accent information that is required for synthesizing the voice of the reading text (Step ST005).

A flow through Step ST006 and a flow through Steps ST007 to ST009, that are to be described later, are executed in parallel.

The synthesis controller 13 outputs the accent information for the reading text to the speech synthesizer 14, and the speech synthesizer 14 generates the synthesized voice of the reading text and outputs it to the speaker 5, to thereby start reading out (Step ST006).

In parallel with Step ST006, the synthesis controller 13 determines whether or not the start time for the voice output has elapsed, for each of the word-of-speech-recognition targets in ascending order of the number of morae from the beginning of the reading text (Step ST007). When the time reaches the start time for the voice output of the word-of-speech-recognition target “prime minister” whose number of morae from the beginning of the reading text is smallest (Step ST007 “YES”), the synthesis controller 13 outputs the word-of-speech-recognition target “prime minister” to the display controller 15 (Step ST008). The display controller 15 issues an instruction to the display 4 to thereby cause it to display the word-of-speech-recognition target “prime minister”.

Subsequently, the synthesis controller 13 determines whether or not the three word-of-speech-recognition targets have all been displayed (Step ST009). At this time, because the word-of-speech-recognition targets “consumption tax” and “deflation” remain non-displayed (Step ST009 “NO”), the synthesis controller 13 repeats two more times Steps ST007 to ST009. The synthesis controller 13 terminates the above series of processing at the time of completion of displaying all the word-of-speech-recognition targets (Step ST009 “YES”).

As the result, in FIG. 2, at the timing where “prime minister” in the reading text “Prime Minister takes policy to start discussion with experts about determination of whether the consumption tax will be raised, ‘to reconsider if departure from deflation is difficult’” is read out, “prime minister” is displayed in the display area C1; at the timing where “consumption tax” is read out, “consumption tax” is displayed in the display area C2; and at the timing where “deflation” is read out, “deflation” is displayed in the display area C3.

When the user speaks the word-of-speech-recognition target displayed in each of the display areas C1 to C3, he/she can receive presentation of the additional information related to the word target. How to present the additional information will be detailed using FIG. 6.

It is noted that, when the word-of-speech-recognition target is to be displayed on the display 4, the display controller 15 may control the display to highlight that word. For highlighting the word-of-speech-recognition target, there are methods of: applying an outstanding character style; enlarging character(s); applying an outstanding character color; blinking each of the display areas C1 to C3; or adding a symbol (for example, “”). Instead, such a method may be used in which the color in each of the display areas C1 to C3 (namely, background color) or the brightness therein is changed before and after the word-of-speech-recognition target is displayed. These types of highlighting may be used in combination.

Further, when the word-of-speech-recognition target is displayed on the display 4, the display controller 15 may control the display to make the display area (C1 to C3) function as a software key for selecting the word-of-speech-recognition target. The software key just has to be operable and selectable by the user using the input device 104, and is provided, for example, as a touch button selectable using a touch sensor, a button selectable using a manipulation device, or the like.

Next, operations of the information presentation system 1 in the case where the user speaks the word-of-speech-recognition target, will be described using the flowchart in FIG. 6.

The speech recognizer 18 acquires through the microphone 6, the voice spoken by the user, and then recognizes it with reference to the recognition dictionary 17 to thereby output the recognition result word string (Step ST101). Subsequently, the retrieving unit 10 retrieves the additional information related to the recognition result such as a word string outputted by the speech recognizer 18, through the network 2 from the Web server 3 or other devices (Step ST102). Then, the synthesis controller 13 determines the accent information required for voice synthesis about the information retrieved by the retrieving unit 10, and outputs it to the speech synthesizer 14 (Step ST103). Lastly, the speech synthesizer 14 generates a synthesized voice, based on the accent information outputted by the synthesis controller 13, and then controls the speaker 5 to output the voice (Step ST104).

It is noted that, in FIG. 6, although the information presentation system 1 is configured to acquire, when the word-of-speech-recognition target is spoken by the user, the additional information related to the word target, followed by outputting the information by voice, the system is not limited thereto and may be configured, for example, to perform a prescribed operation for executing, when the recognized linguistic unit such as a word string is a brand name of a facility, periphery search about that brand name followed by displaying a result of that search, or doing something like that. The additional information may be acquired from an external information source such as the Web server 3 or other devices, or may be acquired from a database or the like included in the information presentation system 1.

Further, although the information presentation system is configured so that the retrieving unit 10 retrieves the additional information after the user speaks, the system is not limited thereto and may be configured so that, for example, the extraction unit 12 not only determines the presence/absence of the additional information, but also acquires and stores the additional information, at the time of extraction of the word-of-speech-recognition target from the reading text.

In conclusion, according to Embodiment 1, the information presentation system 1 is configured to include: the extraction unit 12 for extracting, from among the linguistic units such as word strings included in a reading text, additional information related to the linguistic units which is capable of being acquired from an information source, as a word-of-speech-recognition target; the synthesis controller 13 for outputting the accent information used for synthesizing a voice for reading out the reading text, and the word-of-speech-recognition target extracted by the extraction unit 12; the speech synthesizer 14 for reading out the reading text using the accent information received from the synthesis controller 13; and the display controller 15 for controlling the display 4 to display the word-of-speech-recognition target received from the synthesis controller 13, in synchronization with the timing where the speech synthesizer 14 reads out that word-of-speech-recognition target. The display controller 15 receives the word-of-speech-recognition target from the synthesis controller 13 in synchronization with the timing where the speech synthesizer 14 reads out that word-of-speech-recognition target, and thus causes the display 4 to display the received word-of-speech-recognition target. As the result, when the text is read out, the word-of-speech-recognition target is displayed at the timing where it is read out, so that, even when the reading text is not displayed on the screen or the number of displayable characters on the screen is restricted, it is possible to explicitly present the word-of-speech-recognition target included in the text, to the user.

Further, according to Embodiment 1, the display controller 15 may be configured to control the display 4 to highlight the word-of-speech-recognition target. Thus, it becomes easier for the user to find that the word-of-speech-recognition target has been displayed.

Further, according to Embodiment 1, the display controller 15 may be configured to control the display 4 to make the display area where the word-of-speech-recognition target is displayed, function as a software key for selecting that word-of-speech-recognition target. Thus, the user can separately use both a voice operation and a software-key operation depending on the situation, so that the convenience is enhanced.

### Embodiment 2

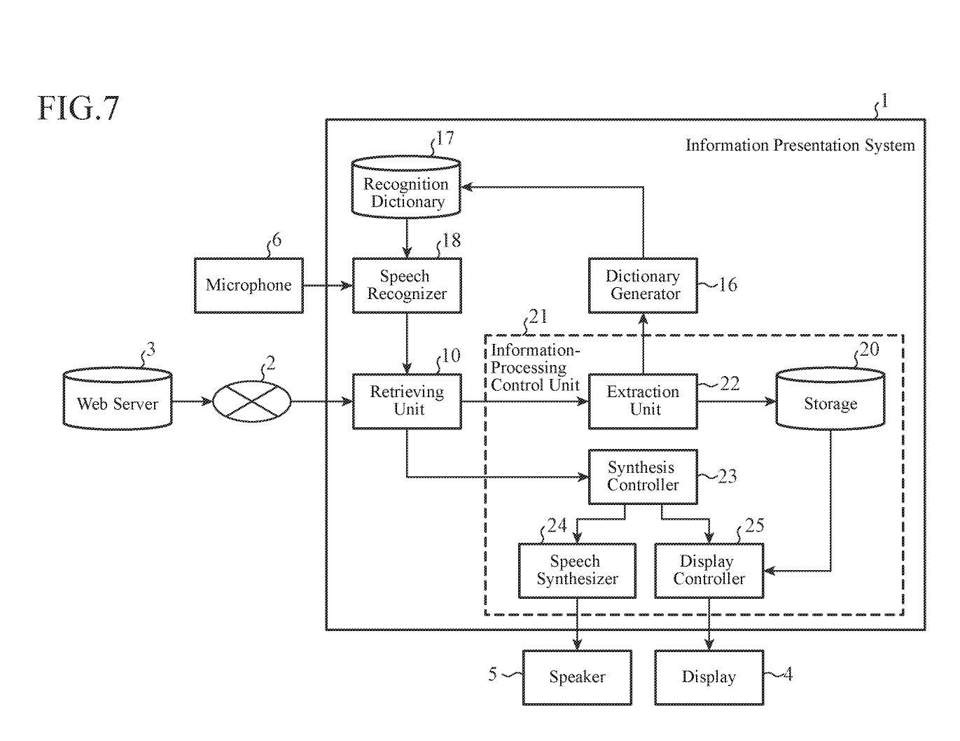

FIG. 7 is a block diagram showing a configuration example of an information presentation system 1 according to Embodiment 2 of the invention. In FIG. 7, for the parts same as or equivalent to those in FIG. 4, the same reference numerals are given, so that their description is omitted here.

The information presentation system 1 of Embodiment 2 includes a storage 20 for storing the word-of-speech-recognition target. Further, an information- processing control unit 21 of Embodiment 2 is partly different in operation from the information-processing control unit 11 of Embodiment 1 and thus will be described below.

Like in Embodiment 1, an extraction unit 22 analyzes the reading text acquired by the retrieving unit 10 to segment the text into one or more linguistic units such as word strings.

The extraction unit 22 of Embodiment 2 extracts, form among the linguistic units such as word strings obtained by the segmentation, the word-of-speech-recognition target, and causes the storage 20 to store the extracted word-of-speech-recognition target.

Like in Embodiment 1, a synthesis controller 23 analyzes the reading text acquired by the retrieving unit 10 to thereby segment the text into the linguistic units such as word strings. In addition, the synthesis controller 23 determines, for each of the linguistic units such as word strings obtained by the segmentation, accent information that is required at the time of voice synthesis. Then, the synthesis controller 23 outputs the determined accent information, per each linguistic unit such as a word string from the beginning of the reading text, to a speech synthesizer 24.

The synthesis controller 23 of Embodiment 2 outputs the accent information to the speech synthesizer 24 and at the same time, outputs the linguistic unit such as a word string corresponding to that accent information to the display controller 25.

Like in Embodiment 1, the speech synthesizer 24 generates a synthesized voice, based on the accent information outputted from the synthesis controller 23, and then controls the speaker 5 to output the synthesized voice.

A display controller 25 of Embodiment 2 determines whether or not the linguistic unit such as a word string outputted from the synthesis controller 23 is present in the storage 20. Namely, it determines whether or not the linguistic unit such as a word string outputted from the synthesis controller 23 is a word-of-speech-recognition target. When the linguistic unit such as a word string outputted from the synthesis controller 23 is present in the storage 20, the display controller 25 controls the display 4 to display that linguistic unit such as a word string, namely, the word-of-speech-recognition target.

It is noted that, in FIG. 7, although the synthesis controller 23 acquires the reading text from the retrieving unit 10 to segment the text into the linguistic units such as word strings, it may instead acquire already-obtained linguistic units such as word strings from the extraction unit 22.

Further, although the display controller 25 determines, with reference to the storage 20, whether or not the linguistic unit such as a word string is a word-of-speech-recognition target, the synthesis controller 23 may instead perform that determination. On this occasion, the synthesis controller 23 determines, when outputting the accent information to the speech synthesizer 24, whether or not the linguistic unit such as a word string corresponding to that accent information is present in the storage 20, and then outputs the linguistic unit such as a word string, if present in the storage 20, to the display controller 25 but does not output the linguistic unit such as a word string, if absent therein. This results in the display controller 25 solely controlling the display 4 to display the linguistic unit such as a word string outputted from the synthesis controller 23.

Further, like in Embodiment 1, at the time the word-of-speech-recognition target is to be displayed on the display 4, the display controller 25 may control the display to highlight that word. Furthermore, the display controller 25 may control the display to make the display area (C1 to C3) (shown in FIG. 2) where the word-of-speech-recognition target is displayed, function as a software key for selecting the word-of-speech-recognition target.

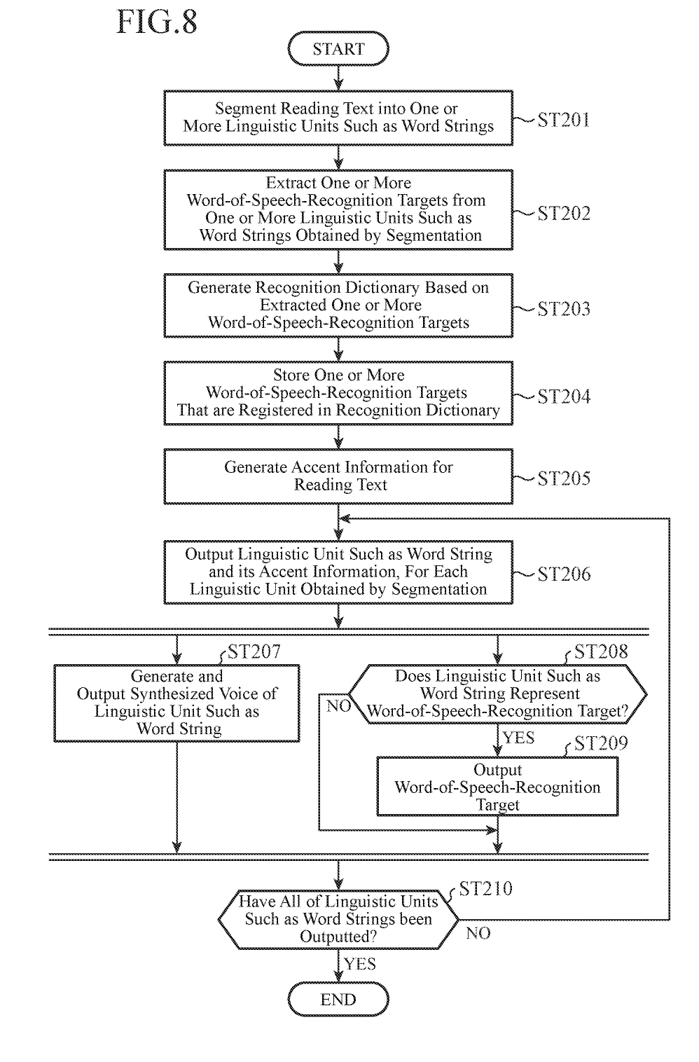

Next, operations of the information-processing control unit 21 will be described using the flowchart in FIG. 8.

Here, descriptions will be made assuming that the reading text is “Prime Minister takes policy to start discussion with experts about determination of whether the consumption tax will be raised, ‘to reconsider if departure from deflation is difficult’”, and the word-of-speech-recognition targets are “prime minister”, “consumption tax” and “deflation”.

Initially, the extraction unit 22 segments the above reading text into one or more linguistic units such as word strings (Step ST201), and extracts each word-of-speech-recognition target from among the linguistic units such as word strings obtained by the segmentation (Step ST202).

At this time, the dictionary generator 16 generates the recognition dictionary 17, based on the above three word-of-speech-recognition targets extracted by the extraction unit 22 (Step ST203).

Further, the extraction unit 22 causes the storage 20 to store the extracted three word-of-speech-recognition targets (Step ST204).

Subsequently, the synthesis controller 23 segments the above reading text into one or more linguistic units such as word strings, and determines their accent information that is required for voice synthesis (Step ST205). Then, the synthesis controller 23 outputs the accent information and the linguistic units such as word strings, per each linguistic unit such as a word string, in order from the beginning (here, “prime minister”) of the obtained linguistic unit such as word strings, to the speech synthesizer 24 and the display controller 25 (Step ST206).

The speech synthesizer 24 generates a synthesized voice of the linguistic units such as word strings, based on the accent information per each linguistic unit such as a word string outputted from the synthesis controller 23, and outputs the voice to the speaker 5 to thereby read out them (Step ST207).

In parallel with Step ST207, the display controller 25 determines whether or not the linguistic unit such as a word string outputted from the synthesis controller 23 is matched to the word-of-speech-recognition target stored in the storage 20 (Step ST208) . When the linguistic unit such as a word string outputted from the synthesis controller 23 is matched to the word-of-speech-recognition target in the storage 20 (Step ST208 “YES”), the display controller 25 controls the display 4 to display that linguistic unit such as a word string (Step ST209). In contrast, when the linguistic unit such as a word string outputted from the synthesis controller 23 is unmatched to the word-of-speech-recognition target in the storage 20 (Step ST208 “NO”), the speech synthesizer 24 skips Step ST209.

Since “prime minister” that is the linguistic unit such as a word string at the beginning of the reading text, is a word-of-speech-recognition target, it is read out and, at the same time, displayed in the display area C1 (shown in FIG. 2) on the display 4.

Subsequently, the synthesis controller 23 determines whether or not the linguistic units such as word strings in the reading text have all been outputted (Step ST210). At this time, because only outputting the linguistic unit such as a word string at the beginning is completed (Step ST210 “NO”), the synthesis controller 23 returns to Step ST206. The synthesis controller 23 terminates the above series of processing at the time of completion of outputting the linguistic units such as word strings from the beginning linguistic unit such as a word string to the last linguistic unit such as a word string in the reading text (Step ST210 “YES”).

As the result, as shown in FIG. 2, at the timings where “prime minister”, “consumption tax” and “deflation” in the reading text “Prime Minister takes policy to start discussion with experts about determination of whether the consumption tax will be raised, ‘to reconsider if departure from deflation is difficult’” are read out, “prime minister”, “consumption tax” and “deflation” are displayed in the display areas C1 to C3.

When the user speaks the word-of-speech-recognition target displayed in each of the display areas C1 to C3, he/she can receive presentation of the additional information related to the word target.

In conclusion, according to Embodiment 2, the information presentation system 1 is configured to comprise: the extraction unit 22 for extracting, from among the linguistic units such as word strings included in a reading text, additional information related to the linguistic units which is capable of being acquired from an information source, as a word-of-speech-recognition target; the synthesis controller 23 for outputting the accent information used for synthesizing a voice for reading out the reading text, and the word-of-speech-recognition target extracted by the extraction unit 22; the speech synthesizer 24 for reading out the reading text using the accent information received from the synthesis controller 23; and the display controller 25 for controlling the display 4 to display the word-of-speech-recognition target received from the synthesis controller 23, in synchronization with the timing where the speech synthesizer 24 reads out that word-of-speech-recognition target. The display controller 25 receives the linguistic unit such as a word string from the synthesis controller 23 in synchronization with the timing where the speech synthesizer 24 reads out that linguistic unit such as a word string, and causes the display 4 to display the received linguistic unit such as a word string when it is a word-of-speech-recognition target. As the result, when the text is read out, the word-of-speech-recognition target is displayed at the timing where it is read out, so that, even when the reading text is not displayed on the screen or the number of displayable characters on the screen is restricted, it is possible to explicitly present the word-of-speech-recognition target included in that text, to the user.

### Embodiment 3

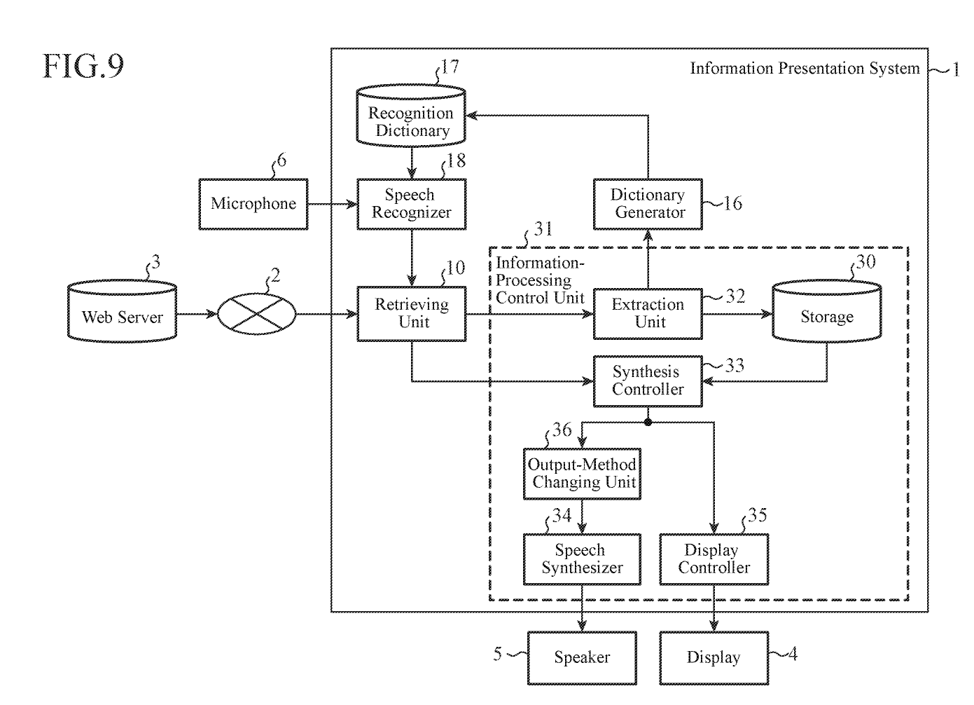

FIG. 9 is a block diagram showing a configuration example of an information presentation system 1 according to Embodiment 3 of the invention. In FIG. 9, for the parts same as or equivalent to those in FIG. 4 and FIG. 7, the same reference numerals are given, so that their description is omitted here.

The information presentation system 1 of Embodiment 3 includes a storage 30 for storing the word-of-speech-recognition target. Further, an information- processing control unit 31 of Embodiment 3 includes an output-method changing unit 36, for dealing differently with the word-of-speech-recognition target and another linguistic unit such as a word string when the reading text is read out.

Since the information-processing control unit 31 of Embodiment 3 includes the output-method changing unit 36, it is partly different from the information-processing control unit 21 of Embodiment 2 and thus will be described below.

Like in Embodiment 2, an extraction unit 32 analyzes the reading text acquired by the retrieving unit 10 to segment the text into one or more linguistic units such as word strings, and then extracts, from among the linguistic units such as word strings obtained by the segmentation, each word-of-speech-recognition target and causes the storage 30 to store that word.

Like in Embodiment 2, a synthesis controller 33 analyzes the reading text acquired by the retrieving unit 10 to thereby segment the text into the linguistic units such as word strings, and determines accent information per each of the linguistic units such as word strings.

The synthesis controller 33 of Embodiment 3 determines whether or not each linguistic unit such as a word string is present in the storage 30. Namely, it determines whether or not the linguistic unit such as a word string is a word-of-speech-recognition target. Then, the synthesis controller 33 outputs the determined accent information, per each linguistic unit such as a word string from the beginning of the reading text, to a speech synthesizer 34. At that time, when the linguistic unit such as a word string corresponding to the outputted accent information is a word-of-speech-recognition target, the synthesis controller 33 controls the output-method changing unit 36 to change the output method for that linguistic unit such as a word string. In addition, when the linguistic unit such as a word string corresponding to the outputted accent information is a word-of-speech-recognition target, the synthesis controller 33 outputs the linguistic unit such as a word string to a display controller 35.

The output-method changing unit 36 redetermines the accent information so as to change the output method, only when it is controlled by the synthesis controller 33 to change the output method for the linguistic unit such as a word string. Changing the output method is accomplished by at least one of methods of: changing read-out pitch (tone of voice); changing read-out speed; changing between presence and absence of a pause before/after reading out; changing sound volume during reading out; and changing between presence and absence of a sound effect during reading out.

In order for the user to easily distinguish in sound between a word-of-speech-recognition target and another linguistic unit such as a word string, it is preferable: to make the pitch for reading out the word-of-speech-recognition target higher; to insert a pause before/after the word-of-speech-recognition target; to make the sound volume for reading out the speech-recognition word louder; and/or to add a sound effect during reading out the word-of-speech-recognition target.

The speech synthesizer 34 generates a synthesized voice, based on the accent information outputted from the output-method changing unit 36, and controls the speaker 5 to output the synthesized voice.

The display controller 35 controls the display 4 to display the linguistic unit such as a word string outputted from the synthesis controller 33. In Embodiment 3, the linguistic units such as word strings outputted from the synthesis controller 33 to the display controller 35 are all the word-of-speech-recognition targets.

It is noted that, in FIG. 9, although the synthesis controller 33 acquires the reading text from the retrieving unit 10 to thereby segment the text into the linguistic units such as word strings, it may instead acquire already-obtained linguistic units such as word strings from the extraction unit 32.

Further, like in Embodiment 1, at the time the word-of-speech-recognition target is to be displayed on the display 4, the display controller 35 may control the display to highlight that word. Furthermore, the display controller 35 may control the display to make the display area (C1 to C3) (shown in FIG. 2) where the word-of-speech-recognition target is displayed, function as a software key for selecting the word-of-speech-recognition target.

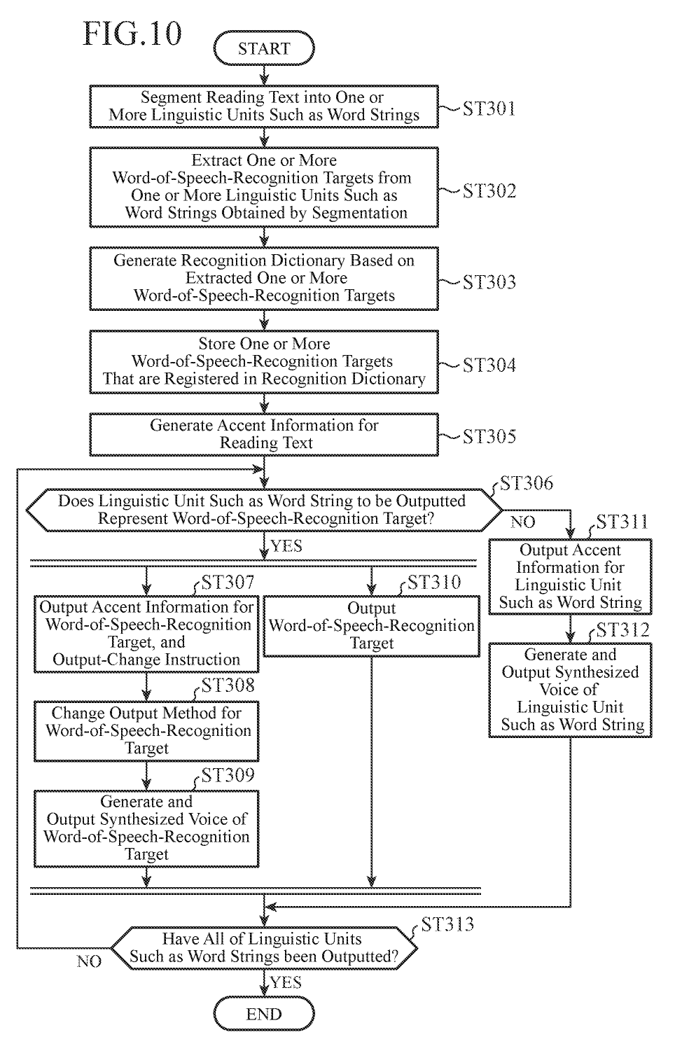

Next, operations of the information-processing control unit 31 will be described using the flowchart in FIG. 10.

Here, descriptions will be made assuming that the reading text is “Prime Minister takes policy to start discussion with experts about determination of whether the consumption tax will be raised, ‘to reconsider if departure from deflation is difficult’”, and the word-of-speech-recognition targets are “prime minister”, “consumption tax” and “deflation”.

Initially, the extraction unit 32 segments the above reading text into one or more linguistic units such as word strings (Step ST301), and extracts each word-of-speech-recognition target from the linguistic units such as word strings obtained by the segmentation (Step ST302).

At this time, the dictionary generator 16 generates the recognition dictionary 17, based on the above three word-of-speech-recognition targets extracted by the extraction unit 32 (Step ST303).

Further, the extraction unit 32 causes the storage 30 to store the extracted three word-of-speech-recognition targets (Step ST304).

Subsequently, the synthesis controller 33 segments the above reading text into linguistic units such as word strings, and determines their accent information that is required for voice synthesis (Step ST305). Then, when the synthesis controller 33 outputs the accent information, per each linguistic unit such as a word string, in order from the beginning (here, “prime minister”) of the obtained linguistic units such as word strings, to the output-method changing unit 36, the synthesis controller determines whether or not the linguistic unit such as a word string is stored in the storage 30, namely, it is a word-of-speech-recognition target or not (Step ST306).

When the linguistic unit such as a word string to be outputted is a word-of-speech-recognition target (Step ST306 “YES”), the synthesis controller 33 outputs the accent information for that linguistic unit such as a word string and a read-out change instruction, to the output-method changing unit 36 (Step ST307).

The output-method changing unit 36 redetermines accent information for the word-of-speech-recognition target according to the read-out change instruction outputted from the synthesis controller 33, and outputs the information to the speech synthesizer 34 (Step ST308).

The speech synthesizer 34 generates a synthesized voice of the word-of-speech-recognition target, based on the accent information redetermined by the output-method changing unit 36, and outputs the voice to the speaker 5 to thereby read out that word (Step ST309).

In parallel with Steps ST307 to ST309, the synthesis controller 33 outputs the word-of-speech-recognition target corresponding to the accent information outputted to the output-method changing unit 36, to the display controller 35 (Step ST310). The display controller 35 controls the display 4 to display the word-of-speech-recognition target outputted from the synthesis controller 33.

Since “prime minister” that is the linguistic unit such as a word string at the beginning of the reading text is a word-of-speech-recognition target, its read out method is changed and, at the same time, it is displayed in the display area C1 (shown in FIG. 2) on the display 4.

In contrast, if the linguistic unit such as a word string to be outputted is not a word-of-speech-recognition target (Step ST306 “NO”), the synthesis controller 33 outputs the accent information for that linguistic unit such as a word string, to the output-method changing unit 36 (Step ST311).

There is no output from the synthesis controller 33 to the display controller 35.

The output-method changing unit 36 outputs the accent information for the linguistic unit such as a word string outputted from the synthesis controller 33, without change, to the speech synthesizer 34, so that the speech synthesizer 34 generates a synthesized voice of the linguistic unit such as a word string, based on that accent information, followed by outputting the voice to the speaker 5, to thereby read out that linguistic unit such as a word string (Step ST312).

Subsequently, the synthesis controller 33 determines whether or not the linguistic units such as word strings from the beginning linguistic unit such as a word string to the last linguistic unit such as a word string in the reading text, have all been outputted (Step ST313). The synthesis controller 33 returns to Step ST306 when outputting all of the linguistic units such as word strings in the reading text has not been completed (Step ST313 “NO”), and terminates the above series of processing when outputting all of them has been completed (Step ST313 “YES”).

As the result, as shown in FIG. 2, at the timings where “prime minister”, “consumption tax” and “deflation” in the reading text “Prime Minister takes policy to start discussion with experts about determination of whether the consumption tax will be raised, ‘to reconsider if departure from deflation is difficult’” are read out, the output method is changed and “prime minister”, “consumption tax” and “deflation” are displayed in the display areas C1 to C3.

When the user speaks the word-of-speech-recognition target, the output method of which has been changed, or which is displayed in each of the display areas C1 to C3, he/she can receive presentation of the additional information related to the word target.

In conclusion, according to Embodiment 3, the information presentation system 1 is configured to comprise:

the extraction unit 32 for extracting among the linguistic units such as word strings included in a reading text, additional information related to the linguistic units which is capable of being acquired from an information source, as a word-of-speech-recognition target; the synthesis controller 33 for outputting the accent information used for synthesizing a voice for reading out the reading text, and the word-of-speech-recognition target extracted by the extraction unit 32; the speech synthesizer 34 for reading out the reading text using the accent information received from the synthesis controller 33; and the display controller 35 for controlling the display 4 to display the word-of-speech-recognition target received from the synthesis controller 33, in synchronization with the timing where the speech synthesizer 34 reads out that word-of-speech-recognition target. The display controller 35 receives the word-of-speech-recognition target from the synthesis controller 33 in synchronization with the timing where the speech synthesizer 34 reads out that word-of-speech-recognition target, and thus causes the display 4 to display the received word-of-speech-recognition target. As the result, when the text is read out, the word-of-speech-recognition target is displayed at the timing where it is read out, so that, even when the reading text is not displayed on the screen or the number of displayable characters on the screen is restricted, it is possible to explicitly present the word-of-speech-recognition target included in that text, to the user.

Further, according to Embodiment 3, the information presentation system 1 is configured to comprise the output-method changing unit 36 by which the output method to be executed by the speech synthesizer 34 is changed between a method for the word-of-speech-recognition target and a method for another word in the reading text. Thus, the user can recognize the word-of-speech-recognition target even in a situation where he/she can't afford watching the screen, such as in the case where the driving-load is high, so that the convenience is enhanced.

Note that the output-method changing unit 36 may be added to the information presentation system 1 of Embodiment 1 or 2.

In Embodiments 1 to 3, although the information presentation system 1 is configured to be adapted to the reading text in Japanese, it may be configured to be adapted to a language other than Japanese.

It should be noted that unlimited combination of the respective embodiments, modification of any configuration element in the embodiments and omission of any configuration element in the embodiments may be made in the present invention without departing from the scope of the invention.

### INDUSTRIAL APPLICABILITY

The information presentation system according to the invention is configured to display, at the time of reading out the text, the word-of-speech-recognition target at the timing where it is read out, so that it is suited to be used in an in-vehicle device, a portable information terminal or the like in which the number of displayable characters on its screen is restricted.

### REFERENCE SIGNS LIST

1: information presentation system; 2: network; 3: Web server (information source); 4: display (display unit); 5: speaker; 6: microphone; 10: retrieving unit; 11, 21, 31: information-processing control unit; 12, 22, 32: extraction unit; 13, 23, 33: synthesis controller; 14, 24, 34: speech synthesizer; 15, 25, 35: display controller; 16: dictionary generator; 17: recognition dictionary; 18: speech recognizer; 20, 30: storage; 36: output-method changing unit; 101: CPU; 102: ROM; 103: RAM; 104: input device; 105: communication device; 106: HDD; and 107: output device.

1. An information presentation system, comprising:
an extraction unit to extract, from among words or word strings being included in a text, information related to said words or word strings which is capable of being acquired from an information source, as a word-of-speech-recognition target;
a synthesis controller to output information for use in speech-synthesis for reading out the text, and the word-of-speech-recognition target extracted by the extraction unit;
a speech synthesizer to read out the text using the information received from the synthesis controller; and
a display controller to control a display unit to display the word-of-speech-recognition target received from the synthesis controller, in synchronization with a timing where the speech synthesizer reads out the word-of-speech-recognition target.

2. The information presentation system according to claim 1, wherein the display controller controls the display unit to highlight display of the word-of-speech-recognition target.

3. The information presentation system according to claim 2, wherein said highlighting display is performed using at least one method selected among: in character style; in character size; in character color; in background color; in brightness; by blinking; and by symbol addition.

4. The information presentation system according to claim 1, further comprising an output-method changing unit to change an output method to be executed by the speech synthesizer, between a method for the word-of-speech-recognition target and a method for another word in the text.

5. The information presentation system according to claim 4, wherein the output method is changed by at least one of: changing of read-out pitch; changing of read-out speed; changing between presence and absence of pauses before/after reading out; changing of sound volume during reading out; and changing between presence and absence of sound effects during reading out.

6. The information presentation system according to claim 1, wherein the display controller controls the display unit to make an area where the word-of-speech-recognition target is displayed, function as a software key for selecting said word-of-speech-recognition target.
